(19) United States
(12) Patent Application Publication
(10) Pub. No.: US 2006/0085784 A1
(43) Pub. Date: Apr. 20, 2006

(54) Systems and methods for authoring and accessing computer-based materials using virtual machines

(75) Inventors: Eric P. Traut, Bellevue, WA (US); Mike Neil, Issaquah, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/966,261

(22) Filed: Oct. 15, 2004

(51) Int. Cl. G06F 9/455

(52) U.S. Cl. 718/1

(57) ABSTRACT

The present invention is directed to a system for authoring and accessing computer-based materials, a high-level method of using the system, and method of saving the state and data from an authoring host onto a storage host. The system and methods employ virtual machines to save the state and data of the authoring host onto a storage host, which can then be accessed by any number of access hosts. Virtual machines are utilized to (1) save snapshots of the state of the processor and devices within the authoring host, and (2) save the data from the authoring host with differencing drives. The present invention solves a large set of problems related to inconsistencies that exist in the combinations of (a) operating systems, (b) hardware, and (c) software on computers.

### CROSS-REFERENCE TO RELATED APPLICATIONS

This application is related to the following commonly-assigned patent applications, the entire contents of each are hereby incorporated herein this present application by reference: U.S. patent application Ser. No. 10/193,531, entitled “METHOD FOR FORKING OR MIGRATING A VIRTUAL MACHINE”, filed Jul. 11, 2002 (Atty. Docket No. MSFT-2562/304106.01).

### FIELD OF THE INVENTION

The present invention generally relates to the field of virtual machines (also known as “processor virtualization”) and software that executes in a virtual machine environment. More specifically, the present invention is directed to using virtual machines for authoring and accessing computer-based materials by using state snapshots (repeatable stores) and differencing drives to establish a set of consistent starting points for modules within the computer-based materials.

### BACKGROUND OF THE INVENTION

Computers include general purpose central processing units (CPUS) that are designed to execute a specific set of system instructions. A group of processors that have similar architecture or design specifications may be considered to be members of the same processor family. Examples of current processor families include the Motorola 680×0 processor family, manufactured by Motorola, Inc. of Phoenix, Ariz.; the Intel 80×86 processor family, manufactured by Intel Corporation of Sunnyvale, Calif.; and the PowerPC processor family, which is manufactured by Motorola, Inc. and used in computers manufactured by Apple Computer, Inc. of Cupertino, Calif. Although a group of processors may be in the same family because of their similar architecture and design considerations, processors may vary widely within a family according to their clock speed and other performance parameters.

Each family of microprocessors executes instructions that are unique to the processor family. The collective set of instructions that a processor or family of processors can execute is known as the processor's instruction set. As an example, the instruction set used by the Intel 80×86 processor family is incompatible with the instruction set used by the PowerPC processor family. The Intel 80×86 instruction set is based on the Complex Instruction Set Computer (CISC) format. The Motorola PowerPC instruction set is based on the Reduced Instruction Set Computer (RISC) format. CISC processors use a large number of instructions, some of which can perform rather complicated functions, but which require generally many clock cycles to execute. RISC processors use a smaller number of available instructions to perform a simpler set of functions that are executed at a much higher rate.

The uniqueness of the processor family among computer systems also typically results in incompatibility among the other elements of hardware architecture of the computer systems. A computer system manufactured with a processor from the Intel 80×86 processor family will have a hardware architecture that is different from the hardware architecture of a computer system manufactured with a processor from the PowerPC processor family. Because of the uniqueness of the processor instruction set and a computer system's hardware architecture, application software programs are typically written to run on a particular computer system running a particular operating system.

Virtual Machines

Computer manufacturers want to maximize their market share by having more rather than fewer applications run on the microprocessor family associated with the computer manufacturers' product line. To expand the number of operating systems and application programs that can run on a computer system, a field of technology has developed in which a given computer having one type of CPU, called a host, will include an emulator program that allows the host computer to emulate the instructions of an unrelated type of CPU, called a guest. Thus, the host computer will execute an application that will cause one or more host instructions to be called in response to a given guest instruction. Thus the host computer can both run software designed for its own hardware architecture and software written for computers having an unrelated hardware architecture. As a more specific example, a computer system manufactured by Apple Computer, for example, may run operating systems and program written for PC-based computer systems. It may also be possible to use an emulator program to operate concurrently on a single CPU multiple incompatible operating systems. In this arrangement, although each operating system is incompatible with the other, an emulator program can host one of the two operating systems, allowing the otherwise incompatible operating systems to run concurrently on the same computer system.

When a guest computer system is emulated on a host computer system, the guest computer system is said to be a “virtual machine” as the guest computer system only exists in the host computer system as a pure software representation of the operation of one specific hardware architecture. The terms emulator, virtual machine, and processor emulation are sometimes used interchangeably to denote the ability to mimic or emulate the hardware architecture of an entire computer system. As an example, the Virtual PC software created by Connectix Corporation of San Mateo, Calif. emulates an entire computer that includes an Intel 80×86 Pentium processor and various motherboard components and cards. The operation of these components is emulated in the virtual machine that is being run on the host machine. An emulator program executing on the operating system software and hardware architecture of the host computer, such as a computer system having a PowerPC processor, mimics the operation of the entire guest computer system.

The emulator program acts as the interchange between the hardware architecture of the host machine and the instructions transmitted by the software running within the emulated environment. This emulator program may be a host operating system (HOS), which is an operating system running directly on the physical computer hardware. Alternately, the emulated environment might also be a virtual machine monitor (VMM) which is a software layer that runs directly above the hardware and which virtualizes all the resources of the machine by exposing interfaces that are the same as the hardware the VMM is virtualizing (which enables the VMM to go unnoticed by operating system layers running above it). A host operating system and a VMM may run side-by-side on the same physical hardware.

Accessing Computer Based Materials

In technical training and demonstration scenarios, there are many situations in which it is desirable to skip ahead or backward in time to pre-determined (and established) points in time. In computer-based (CB) training classes, this enables the student to review and preview materials as needed. In technical demonstrations, this allows the presenter who is accessing CB materials to save time by highlighting the most relevant pieces of the demonstration for the audience.

CB training classes are typically taught either in classrooms or through e-training (in which the class is taught remotely via the Internet or other communications links). In these classes, course materials are typically organized by chapter, and the material of each chapter builds upon the material learned in previous chapters.

CB training students benefit from moving freely among the chapters. This freedom of movement allows the student to preview upcoming materials and to review materials as needed to ensure understanding. In marketing applications, technical product and sales representatives need to demonstrate pieces of computer software and systems without necessarily demonstrating all of the functions of the software and systems. Presently, technical product and sales representatives must wait for all processing steps to complete, which is not always the best use of valuable presentation time. It would save time for the representative if he or she could skip to pre-determined (and thoroughly tested) points in the system and software without waiting for processing time. What is needed is a way to allow access to a computer's state and data at pre-determined points in time.

The computers within classrooms are typically not wholly reconfigured between classes due to the time and expense associated with such reconfiguration. The inconsistency in the configuration (e.g., hardware, software, operating systems) of the computers in the classroom results in often unpredictable results during hands-on exercises. This unpredictability decreases the quality of the training experience due to difficulties in explaining how or why something happened on one computer vs. another given the same inputs.

Moreover, in e-training, it is impossible to re-configure the computers used because there is no access to the computer due to its remote physical location. When configurations on the remote computer impact the task being trained, the quality of the training is limited by the extent to which these states or configurations impact the desired results. This is especially true when the subject matter being taught relates to the operating system (OS), or the administration of the computer, and the state of the computer used in the e-training class directly impacts the results during the training exercises.

In some training classes, like “server administration” classes, it is particularly helpful for the student to have access to specific OS versions. In server administration classes conducted by e-training where the remote computer does not have the server OS installed, the amount of “hands-on training” that can be experienced by the student taking the class is very limited. Additionally, it is unlikely that students would have access to more than one OS version at a time. If the number of OS versions that the student could access during a training class were increased, the breadth of the training could be increased and the quality of the training classes would be increased. What is needed is a way to standardize the configuration of a computer for the purposes of starting an e-training class from a clean starting point.

It is financially difficult for students to purchase the computer hardware and software to enable them to obtain hands-on computer training. Personal computers (PC) cost at least $500 USD and servers are at least double the cost of PCs. Additionally, the cost of operating system software ranges from free (some versions of Linux) to many thousands of dollars, such as enterprise server licenses from Microsoft (such as Windows Server 2003, Enterprise Edition, 32-bit version) or Sun (such as Trusted Solaris 8 Enterprise Server Software License Certified Edition). In order to sell the OSs they produce, OS companies (like Sun and Microsoft) need professionals who are trained to administer these OSs. The number of different versions of OS upon which students can be trained is limited due to the cost and time required for students to load these versions on various combinations of hardware. The breadth of training could be improved if these difficulties could be worked out and if students could quickly and inexpensively load and unload versions and configurations of computers.

There are nearly infinite combinations of OSs, hardware, and software installed on any individual computer. The infinite nature of these combinations creates some conflicts and errors that are difficult (if not impossible) to predict or anticipate. Such unpredictable errors are frustrating for authors and users of CB materials. The e-training experience would be substantially improved by increasing relevant, reliable, and predictable hands-on training. Hands-on training in e-training is most relevant, reliable, and predictable when the OS version the student is using exactly matches the OS version the instructor is referencing. These unpredictable errors are also embarrassing, frustrating, and, most importantly, costly for technical product and sales representatives. When accessing CB materials in a sales or technical demonstration, any unexpected errors will negatively impact the desired result of the presentation (usually product sales). By increasing the repeatability and predictability of the CB materials, the quality of CB training classes and CB technical demonstrations would be improved. For example, by eliminating OS versions as a source of discrepancies, the quality of the questions and answers between student and instructor would be improved.

It is difficult for authors of CB training to develop successful hands-on training materials for students and instructors, given the unpredictable combinations of OS, hardware, and software combinations on any computer. Without a known baseline environment, the author or instructor cannot be sure what is causing some errors that a student is experiencing. In this scenario, it is difficult for the author or instructor to determine whether the error is the result of a mistake that the student made or the result of an unanticipated configuration on the computer upon which the student is learning.

It is difficult for authors of CB materials to develop successful hands-on technical (systems and software) demonstrations, given the unpredictable combinations of OS, hardware, and software combinations on any computer. Without a known baseline environment, the author cannot be sure what is causing errors that a presenter experiences. In this scenario, it is difficult for the author or presenter to determine whether the error is the result of a mistake or the result of an unanticipated configuration on the computer upon which the presentation is being performed.

Software engineers spend a large portion of their time debugging the computer programs that they create. During program debugging, software engineers must often wait for the error to occur. For example, if a reproducible error occurs ten minutes into a software program's running time, the engineer spends ten minutes waiting for the error to occur after each attempt to correct the error. If it takes the engineer six attempts to fix the error, this is almost an hour of wasted time.

What is missing in the art is a solution that enable one to quickly reconfigure computers with a consistent configuration; to standardize the configuration of a computer for the purposes of starting an e-training class from a clean starting point; to standardize the configuration of a computer for the purposes of starting an e-training class from a clean starting point; to inexpensively and rapidly configure computers with a variety of OS, software, and hardware combinations; to enable users of CB materials to easily and inexpensively use a specific combination of OS, hardware, and software for the purposes of providing relevant, reliable, and predictable hands-on demonstrations; to author CB training classes that provides a clean baseline computing environment; to author CB materials, such as those for CB demonstrations, that provides a clean baseline computing environment; to decrease the amount of waiting time that software engineers spend during software debugging; and to provide an inexpensive and consistent computing environment for demonstrations combined with a way to author and navigate through CB materials. Various embodiment of the present invention address these and other shortcoming in the art.

### SUMMARY OF THE INVENTION

Various embodiments of the present invention are directed to systems and methods for authoring and accessing computer-based materials, a high-level method of using the system, and method of saving the state and data from an authoring host onto a storage host. The system and methods employ virtual machines to save the state and data of the authoring host onto a storage host, which can then be accessed by any number of access hosts. Virtual machines are utilized to (1) save snapshots of the state of the processor and devices within the authoring host, and (2) save the data from the authoring host with differencing drives. The present invention solves a large set of problems related to inconsistencies that exist in the combinations of (a) operating systems, (b) hardware, and (c) software on computers.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram representing a computer system in which aspects of the present invention may be incorporated;

FIG. 2 illustrates the logical layering of the hardware and software architecture for an emulated operating environment in a computer system;

FIG. 3A illustrates a virtualized computing system;

FIG. 3B illustrates an alternative embodiment of a virtualized computing system comprising a virtual machine monitor running alongside a host operating system;

FIG. 4 is a block diagram illustrating one embodiment of the present invention for authoring and accessing digital content, including virtual machine snapshots.

FIG. 5 is a process flow diagram illustrating a method of several embodiments of the present invention for accessing digital content, including virtual machine snapshots.

FIG. 6 is a process flow diagram illustrating a method of several embodiments of the present invention for authoring digital content, including virtual machine snapshots.

### DETAILED DESCRIPTION OF ILLUSTRATIVE EMBODIMENTS

The inventive subject matter is described with specificity to meet statutory requirements. However, the description itself is not intended to limit the scope of this patent. Rather, the inventor(s) has (have) contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

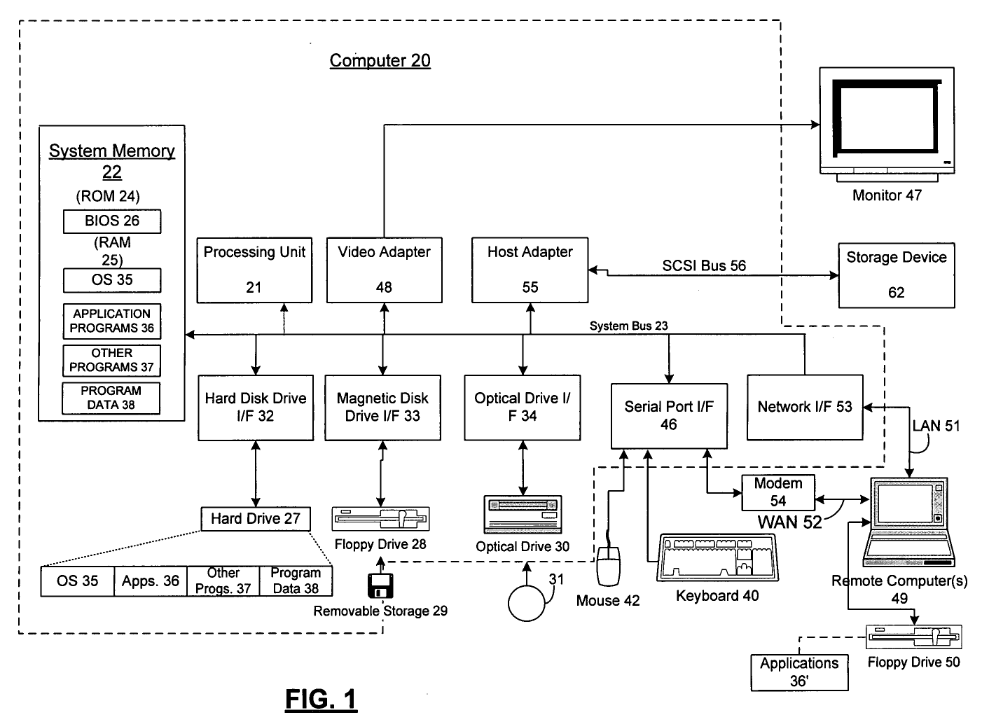

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used. Moreover, while it is envisioned that numerous embodiments of the present invention are particularly well-suited for computerized systems, nothing in this document is intended to limit the invention to such embodiments.

Virtual Machines

From a conceptual perspective, computer systems generally comprise one or more layers of software running on a foundational layer of hardware. This layering is done for reasons of abstraction. By defining the interface for a given layer of software, that layer can be implemented differently by other layers above it. In a well-designed computer system, each layer only knows about (and only relies upon) the immediate layer beneath it. This allows a layer or a “stack” (multiple adjoining layers) to be replaced without negatively impacting the layers above said layer or stack. For example, software applications (upper layers) typically rely on lower levels of the operating system (lower layers) to write files to some form of permanent storage, and these applications do not need to understand the difference between writing data to a floppy disk, a hard drive, or a network folder. If this lower layer is replaced with new operating system components for writing files, the operation of the upper layer software applications remains unaffected.

The flexibility of layered software allows a virtual machine (VM) to present a virtual hardware layer that is in fact another software layer. In this way, a VM can create the illusion for the software layers above it that said software layers are running on their own private computer system, and thus VMs can allow multiple “guest systems” to run concurrently on a single “host system.”

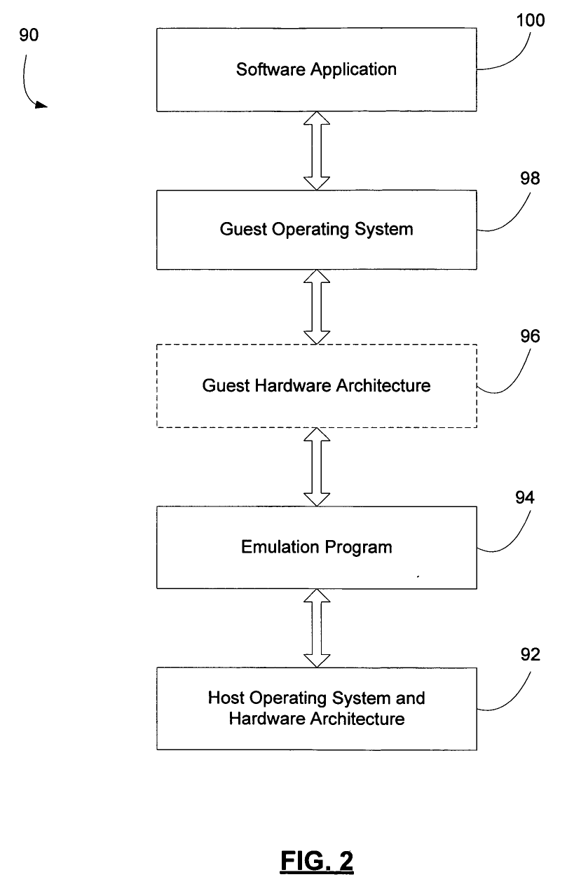

FIG. 2 is a diagram representing the logical layering of the hardware and software architecture for an emulated operating environment in a computer system. An emulation program 94 runs on a host operating system and/or hardware architecture 92. Emulation program 94 emulates a guest hardware architecture 96 and a guest operating system 98. Software application 100 in turn runs on guest operating system 98. In the emulated operating environment of FIG. 2, because of the operation of emulation program 94, software application 100 can run on the computer system 90 even though software application 100 is designed to run on an operating system that is generally incompatible with the host operating system and hardware architecture 92.

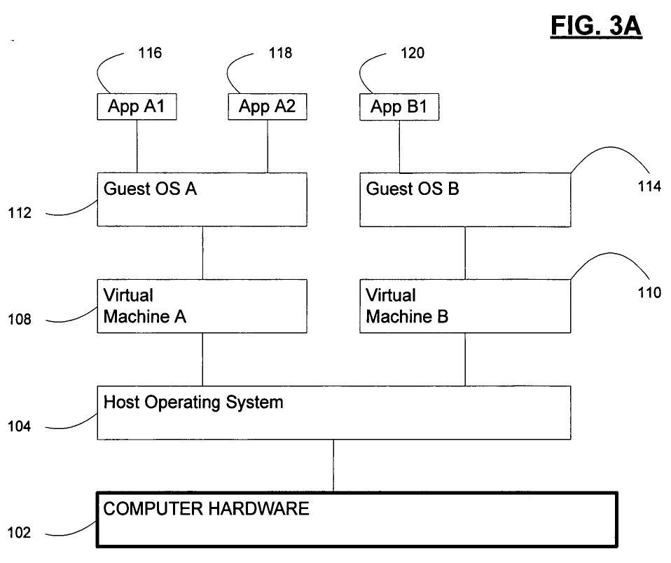

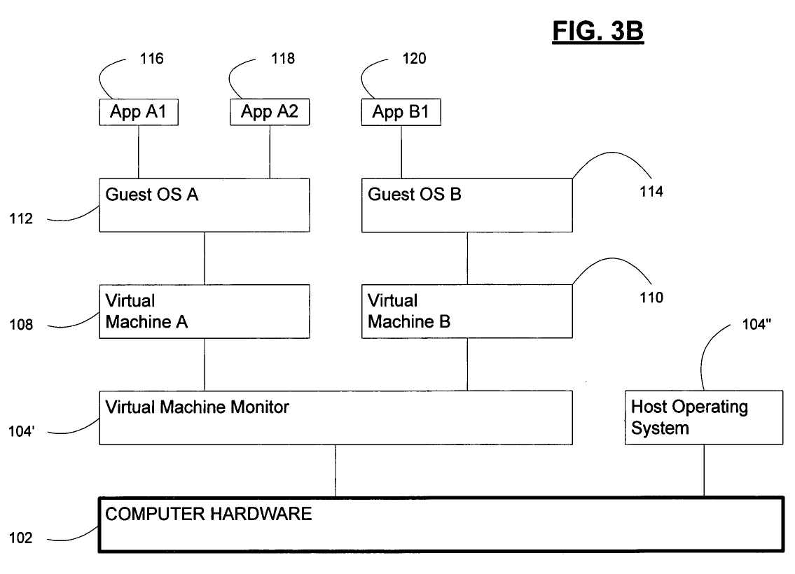

FIG. 3A illustrates a virtualized computing system comprising a host operating system software layer 104 running directly above physical computer hardware 102, and the host operating system (host OS) 104 virtualizes all the resources of the machine by exposing interfaces that are the same as the hardware the host OS is virtualizing (which enables the host OS to go unnoticed by operating system layers running above it).

The host operating system software layer 104 may, for certain embodiments, comprise a hypervisor. A hypervisor is a control program that exists near the kernel level of a host operating system and operates to allow one or more secondary operating systems, other than the host operating system, to use the hardware of the computer system, including the processor of the computer system. A hypervisor of an operating system emulates the operating environment of the secondary operating system so that the secondary operating system believes that it is operating in its customary hardware and/or operating system environment and that it is in logical control of the computer system, when it may in fact be operating in another hardware and/or operating system environment and the host operating system may be in logical control of the computer system. Many operating systems function such that the operating system must operate as though it is in exclusive logical control of the hardware of the computer system. For multiple operating system to function simultaneously on a single computer system, the hypervisor of each operating system must function to mask the presence of the other operating systems such that each operating system functions as though it has exclusive control over the entire computer system.

Alternately, a virtual machine monitor, or VMM, software layer 104′ may be running in place of or alongside a host operating system 104″, the latter option being illustrated in FIG. 3B. For simplicity, all discussion hereinafter (specifically regarding the host operating system 104) shall be directed to the embodiment illustrated in FIG. 3A; however, every aspect of such discussion shall equally apply to the embodiment of FIG. 3B wherein the VMM 104′ of FIG. 3B essentially replaces, on a functional level, the role of the host operating system 104 of FIG. 3A described herein below.

Referring again to FIG. 3A, above the host OS 104 (or VMM 104′) are two virtual machine (VM) implementations, VM A 108, which may be, for example, a virtualized Intel 386 processor, and VM B 110, which may be, for example, a virtualized version of one of the Motorola 380×0 family of processors or an Intel 486 processor, Intel 586 process, etc. Above each VM 108 and 110 are guest operating systems (guest OSs) A 112 and B 114 respectively. Above guest OS A 112 are running two applications, application A1 116 and application A2 118, and above guest OS B 114 is Application B1 120.

CB Materials—Authoring and Accessing

Various embodiments of the present invention are directed to (1) a system for authoring and accessing computer-based materials, (2) a high-level method of using the system, and/or (3) a method of saving the state and data from an authoring host onto a storage host.

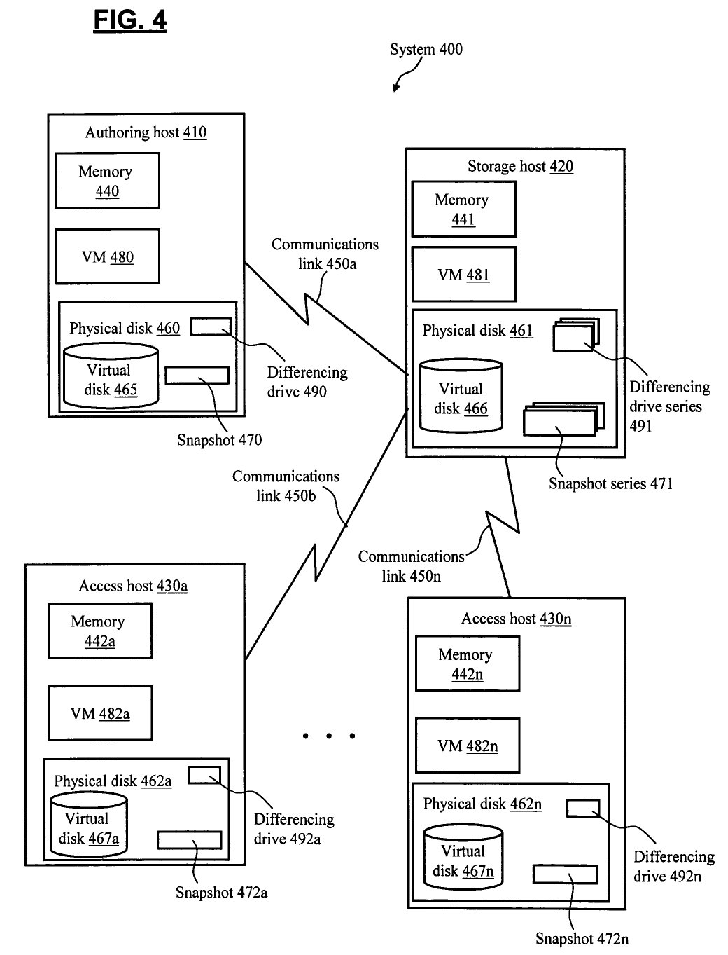

FIG. 4 is a block diagram illustrating a system 400 for authoring and accessing computer-based materials, including: an authoring host 410, a storage host 420, and one or more access hosts 430 (represented herein by an access host 430a through an access host 430n). Authoring host 410 and access hosts 430 are connected to storage host 420 by one or more communications links 450 (represented herein by a communications link 450a, a communications link 450b, through a communications link 450n). Authoring host 410 contains a memory 440, a virtual machine (VM) 480, and a physical disk 460. Physical disk 460 further contains a virtual disk 465, a differencing drive 490, and a snapshot 470.

Access hosts 430 similarly each contain a memory 442, a VM 482, and a physical disk 462. Each physical disk 462 further contains a virtual disk 467, a differencing drive 492, and a snapshot 472. Storage host 420 contains a memory 441, a VM 481, and a physical disk 461. Physical disk 461 further contains a virtual disk 466, a differencing drive series 491, and a snapshot series 471. Physical disk 460, physical disk 461, and physical disks 462 are conventional hard disk drives, such as SCSI or IDE magnetic disk drives. Physical disk 461 may differ from physical disks 460 and 462 in that it has a larger storage capacity, which is important to fulfilling its role as storage receptacle for differencing drive series 491 and snapshot series 471.

Authoring host 410, storage host 420, and access hosts 430 are computing means such as a personal computer, server, or mainframe computer. Authoring host 410, storage host 420, and access hosts 430 run VM 480, VM 481, and VM 482, respectively. Authoring host 410, storage host 420, and access hosts 430 may be running different operating systems (OSs) on different processor architectures. However, it is a requirement of the present invention that authoring host 410 and access hosts 430 are compatible to the extent that they are able to run the same virtual processor (e.g., x86 or SPARC) and the same core virtual devices (e.g., PCI devices or memory devices) as each other. This minimal compatibility is important to ensure that access hosts 430 are able to load snapshot files (e.g., snapshot 472) and differencing drives (e.g., differencing drive 492) stored by authoring host 410 as part of a demonstration in CB materials.

Access host 430n and its components (memory 442n, VM 482n, physical disk 462n, virtual disk 467n, snapshot 472n, and differencing drive 492n) are shown in FIG. 4 in order to illustrate that storage host 420 could be used to provide snapshot files to more than one access host. There could be any number of access hosts 430 in system 400. Storage host 420 is similar to authoring host 410 and access host 430 and, in some cases, these hosts may be identical. The primary difference between storage host 420 and authoring host 410 or access host 430 is that physical disk 461 requires a larger storage capacity than physical disks 460 or 462.

Memory 440, memory 441, and memory 442 are non-persistent storage means such as random access memory (RAM). Memory 440, memory 441, and memory 442 typically comprise the top layers of a data storage subsystem. Communications links 450 are channels by which data can be transmitted between hosts (e.g., between authoring host 410 and storage host 420) in system 400. Communications links 450 may be any of the following including, but not limited to, a conventional 400 MB/s Ethernet cable, a conventional 4 GB/s Ethernet cable, fiber optic cable, and so forth.

VM 480, VM 481, and VM 482 are virtual machine software. VM 480, VM 481, and VM 482 minimally provide authoring host 410, storage host 420, and access host 430, respectively, with a means for processor virtualization and a means for device emulation. VM 480, VM 481, and VM 482 may be either a “hosted virtual machine” or a “self-hosted model.” In hosted virtual machine products, a host OS supports a number of guest OSs running in a virtual machine environment. In self-hosted virtual machines, a hypervisor provides a software layer that operates between the hardware within the computing means, allowing a processor to support a number of guest operating systems. Processor virtualization synthesizes a processor in such a way that software functions on the synthetic processor as if the software were running on a conventional, dedicated processor. Device emulation allows synthesis of peripheral devices within a computer, such as an interrupt controller, a PCI bus, a video display, a keyboard, a mouse, a network card, etc. Both processor virtualization and device emulation functionalities within VM 480, VM 481, and VM 482 contain the state of the processor and devices.

Virtual disk 465, virtual disk 466, and virtual disk 467 are virtual hard drives. Virtual hard drives are actually physical files within physical disks 460, 461, and 462. Virtual disks 465, 466, and 467 are virtualized by VM 480, VM 481, and VM 482, respectively. Virtual disks 465, 466, and 467 are “virtualized” because, while these are not physical disks, the VM software (e.g., VMs 480, 481, and 482) treats the virtual disk as if it were a physical disk. Additionally, there may be more than one virtual disk within physical disks 460, 461, and 462. In one example, virtual disk 465 (or virtual disk 466 or virtual disk 467) starts as a small file on the hard drive of authoring host 410 and grows as more storage is needed. In another example, virtual disk 465 (or virtual disk 466 or virtual disk 467) has a static file size and each virtual OS that is operating within authoring host 410 operates on the assumption that it has the entire physical hard drive available.

Differencing drive 490 is a writable file that stores the difference in data stored in virtual disk 465 since the last differencing drive was created. For example, differencing drive 490 stores the data that has changed between the last time that a parent image of virtual disk 465 was saved and the current state of virtual disk 465. Differencing drive series 491 contains a series of differencing drives that correspond to snapshot series 471 within storage host 420. The differencing drives contained within differencing drive series 491 were originally captured as differencing drive 490 on authoring host 410. Differencing drive 492 is a differencing drive from differencing drive series 491 that has been transferred to access host 430 for hands-on training. By opening differencing drive 492 with VM 482, the user of access host 430 loads the computer data that the author of CB materials intended when differencing drive 490 was saved into differencing drive series 491 (and subsequently renamed differencing drive 492 upon retrieval by access host 430). However, unlike differencing drive 490, differencing drive 492 is a read-only file.

Differencing drives are used within VMs to save capacity within physical disks by saving only the difference between the last time the data of the virtual disk was saved and the time that a snapshot is created. Differencing drives are used to store data in persistent storage, and these are stored in a separate file than the snapshot files that store the state of the processor, devices, and memory. In another example, differencing drives and snapshot files are combined into one file. A more complete description of differencing drives is found within U.S. Patent Application No. 20020147862, invented by Eric Traut, Aaron Giles, and Parag Chakraborty, which is incorporated here by reference.

Snapshot 470 is a writable file containing the state of the processor, devices, and memory of authoring host 410. Snapshot series 471 is a collection (at least one) of snapshot files, and is stored on storage host 420. The snapshots contained within snapshot series 471 were originally captured as snapshot 470 on authoring host 410. Snapshot 470 is transferred from authoring host 410 to storage host 420 and is appended to snapshot series 471 for the purposes of making the snapshot available to access host 430. Snapshot 472 is a snapshot file from snapshot series 471 that has been transferred to access host 430 for hands-on training. By opening snapshot 472 with VM 482, the user of access host 430 loads the computer state that the author of CB materials intended when snapshot 470 was saved into snapshot series 471 (and subsequently renamed snapshot 472 upon retrieval by access host 430). However, unlike snapshot 470, snapshot 472 is a read-only file. Snapshots are used to store the state of the processor(s), devices, and memory within a virtual machine. Snapshots may be opened with VM software, restoring the state of the processor, devices, and memory. Snapshots additionally contain information (e.g., a pointer) about the specific differencing drive that contains the data relevant to each snapshot. Snapshots are stored in a separate file than differencing drives that save the data. In another example, differencing drives and snapshot files are combined into one file. Thus, by opening both snapshot 472 and differencing drive 492, the user of access host 430 is able to load the state and data intended by the author of CB materials.

In operation, a CB materials author using authoring host 410 creates CB materials, and uses VM 480 to create snapshot 470, and differencing drive 490, in order to provide hands-on demonstrations. Authoring host 410, storage host 420, and access host 430 operate within system 400. The CB materials author directs authoring host 410 to save snapshot 470 into snapshot series 471 and to save differencing drive 490 into differencing drive series 491, via communications link 450a within system 400. The state of the processors and devices within authoring host 410 is periodically stored and sent via communications link 450a to storage host 420, where the states are stored in snapshot series 471 on physical disk 461. The frequency With which snapshot 470 is saved into snapshot series 471 and the frequency with which differencing drive 490 is saved into differencing drive series 491 are determined by the CB materials author who is operating authoring host 410, based on what is appropriate to provide hands-on examples to accompany the CB materials.

A user directs access host 430 to access storage host 420. When the CB materials prompt the user to conduct hands-on exercises, the user instructs access host 430 to access a particular snapshot within snapshot series 471 and a particular differencing drive within differencing drive series 491, via communications link 450b (or communications link 450n). The snapshot and differencing drive are transferred from physical disk 461, across communications link 450b (or communications link 450n) to physical disk 462, where they are renamed snapshot 472 and differencing drive 492. Then, VM 482 opens snapshot 472 and differencing drive 492 to load the state and data appropriate to the CB materials and to conduct the hands-on demonstrations.

Authoring and Access

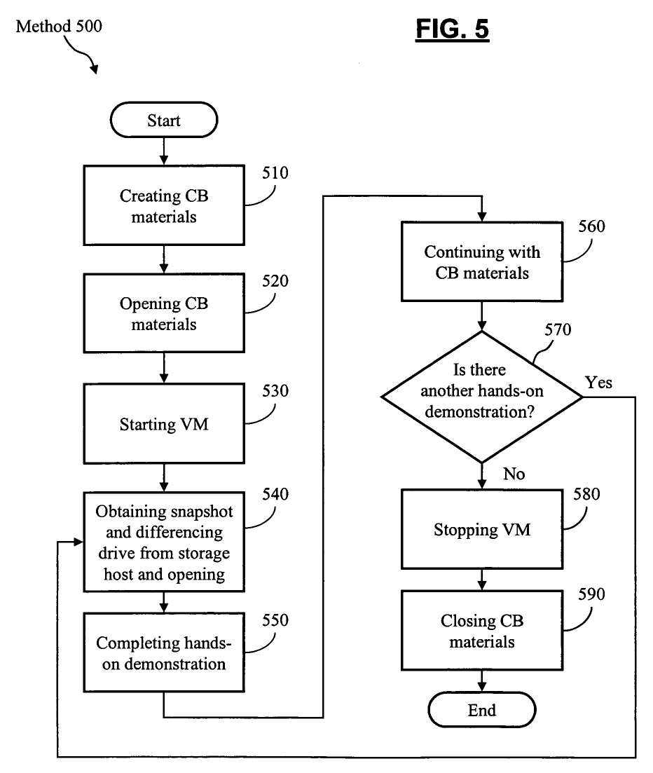

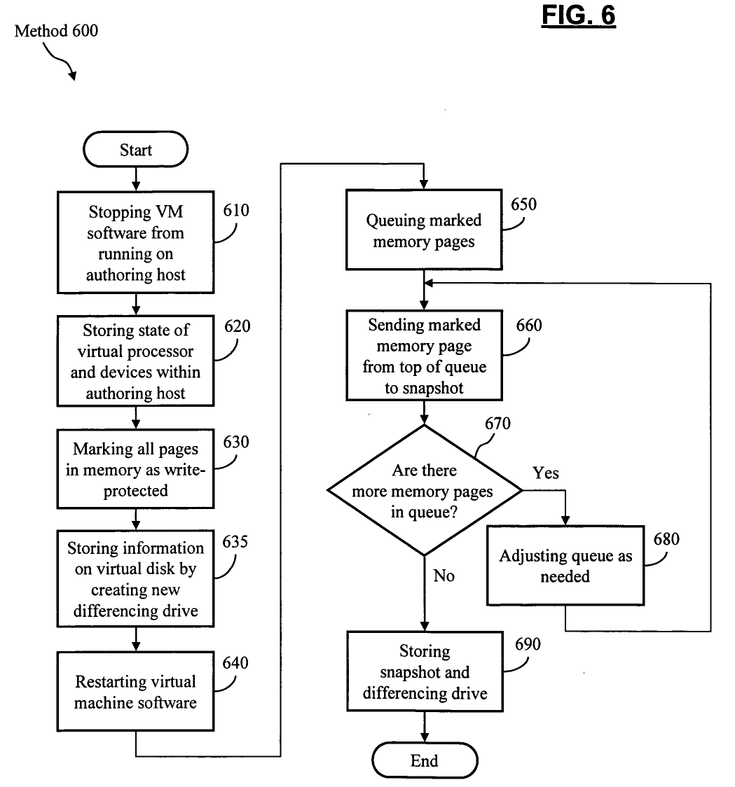

FIG. 5 illustrates a high-level method of utilizing system 400 that is representative of several embodiments of the present invention. In the method 500, and at step 510, a CB materials author periodically directs VM 480 within authoring host 410 to save snapshot 470 into snapshot series 471, and to save differencing drive 490 into differencing drive series 491 within physical disk 461 on storage host 420 for the purposes of providing hands-on training materials. (Additional details of this process are described in reference to FIG. 6 herein below.) In addition to saving snapshot series 471 and differencing drive series 491, the CB materials author may also create text and a user interface to deliver the content of the CB materials. The user interface allows the user to move freely through the CB materials. The user interface additionally allows the user to select a starting point each time the CB materials are opened. In one example, the user interface is a graphical user interface (GUI).

At step 520, a user operating access host 430 opens the CB materials through the user interface designed in step 510. For example, the user could be a student opening a particular chapter of a CB training class, or the user could be a sales representative opening a technical demonstration. At step 530, the user starts VM 482 in preparation for starting a hands-on demonstration. (For certain alternative embodiments, the CB materials contain a script that automatically starts VM 482.) Then at step 540, VM 482 requests the appropriate snapshot file from snapshot series 471 and the appropriate differencing drive from differencing drive series 491 to provide the hands-on demonstration that corresponds to the CB materials. The snapshot file and differencing drive are transferred from storage host 420 to access host 430 via communications link 450. Once the snapshot file and differencing drive are received on access host 430, they are stored on physical disk 462 and are renamed snapshot 472 and differencing drive 492, respectively. VM 482 opens snapshot file 472 and restores the appropriate state and data for the hands-on demonstration. At step 550, the user completes the tasks within the hands-on exercise using access host 430 and, at step 560, the CB training class continues and the student moves on to the next lesson in the class, or the sales representative continues the technical demonstration.

At step 570, if there is another hands-on exercise to be performed in the CB materials then the process returns to step 540; if not, then at step 580 the user stops VM 482 in preparation for completing the CB materials. (For certain alternative embodiments, software-based CB materials contain a script that automatically stops VM 482.) Then at step 590 (after all of the CB materials have been reviewed) the hands-on demonstrations are complete and the CB materials are close, thus ending the process.

In one example, the user described in method 500 is a student using access host 430 to access CB training class materials and hands-on demonstrations that are stored on storage host 420. In this embodiment, there may be additional steps added to method 500 for testing and evaluation. For example, a step 555 could be added to test the student's understanding of the class materials after the hands-on demonstration is complete.

In another example, the user described in method 500 is a sales (or product) representative using access host 430 to access CB sales materials and hands-on demonstrations that are stored on storage host 420. In this example, there may be additional steps added to method 500 to customize the presentation for a particular audience. For example, a step 515 could be added to allow the presenter to load examples or data that are relevant to the audience of the presentation.

In yet another example, the user described in method 500 is a software engineer using access host 430 to access pre-determined processing points in a software program. This allows the software engineer to decrease the amount of time spent waiting for a software program to run during software debugging. In this example, the software engineer acts as the author and the user in method 500. With the software engineer as author and user, there is no need to develop a user interface in step 510. Moreover, in this example, if an error occurs after a computer program has been running for ten minutes, the software engineer saves snapshot 470 and differencing drive 490 to physical disk 461 in storage host 420 after, for example, nine minutes and forty-five seconds (fifteen seconds before the error). This enables the software engineer to wait only fifteen seconds before the error occurs when testing his or her debugging solution.

Data Storage Methodology

FIG. 6 illustrates a method 600 for saving the state of processor and devices from authoring host 410 onto storage host 420. Initially, at step 610, authoring host 410 is stopped in preparation for saving its state data into snapshot 470. In this step, there is also a brief period of waiting for any previously submitted I/O requests that have not completed to finish. In one example, this waiting period is a few microseconds. In another example, the pending I/O request is a disk action and the waiting period is a few milliseconds. The process of stopping authoring host 410 includes stopping VM 480 from running on authoring host 410. By limiting the activity on authoring host 410 at time of snapshotting (e.g., using the repeatable store), snapshot 470 is created without ongoing I/O activity changing the state of the machine before snapshot 470 is completed.

At step 620 the state of the virtual processor and all synthetic devices within authoring host 410, excluding the memory subsystem, is saved synchronously into snapshot 470. At step 630, all pages in memory 440 are marked as write-protected. This allows for a minimally intrusive way of saving the state of memory 440. Because marking the memory pages is a fast process, there is minimal (if any) noticeable effect on the user of production host 410. In an example in which all the pages are also stored instead of just being marked, step 630 may take 5-10 seconds to complete. At step 635, user instructs VM 480 to create differencing drive 490 within physical disk 460. Creating differencing drives each time method 600 is run allows for a more efficient and flexible use of resources than if a complete snapshot of virtual disk 460 were saved each time. At step 640 VM 480 is started again, reversing the stoppage that occurred in step 610, and at step 650 the memory pages marked in step 630 are queued up in memory 440 in preparation for sending to snapshot 470 on physical disk 460. Then at step 660 the memory page from the top of the queue is stored in snapshot 470 on physical disk 460.

At step 670, the system 400 determines whether there are more memory pages in queue to be sent to snapshot 470 and, if so, then at step 680 VM 480 re-orders or adjusts the queue of memory pages as needed and returns to step 660 for further processing. Marking the pages (in step 630) allows VM 480 to make adjustments to this queue based on need for the memory pages within authoring host 410. In an example in which VM 480 needs to write to a memory page that has not yet been sent to snapshot 470, the queue is re-ordered with the particular memory page that VM 480 needs to write to at the top of the queue. In another example in which VM 480 needs to write to a memory page that has not yet been sent to snapshot 470, the queue is not re-ordered; rather, a copy of the particular memory page is created and added to the queue, and the memory page itself is un-marked, allowing VM 480 access to that page. Either of these examples allow VM 480 access to the page as quickly as possible with minimal disruption to production host 410. Method 600 then returns to step 660.

When the method finally proceeds to step 690, the method calls for the storage of the snapshot 470 and the differencing drive 490 snapshot 470 and differencing drive 490 are saved in snapshot series 471 and differencing drive series 491, respectively, for use as a starting point in a hands-on exercise. In one example, snapshot 470 and differencing drive 490 are first stored on physical disk 460 and are subsequently sent to physical disk 461 via communications link 450a after the file is complete. In another example, snapshot 470 and differencing drive 490 are directly written to snapshot series 471 and differencing drive series 491 on physical disk 461 via communications link 450a. After the completion of step 690, method 600 ends.

For certain alternative embodiments, a software program (not shown) installed and running on authoring host 400 is capable of suggesting to the CB materials author when to save the state and data of authoring host 410. The software program monitors authoring host 410 and, when certain criteria are met, the program prompts the author to save snapshot 470 and differencing drive 490.

### CONCLUSION

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly. Likewise, the use of synthetic instructions for purposes other than processor virtualization are also anticipated by the disclosures made herein, and any such utilization of synthetic instructions in contexts other than processor virtualization should be most broadly read into the disclosures made herein.

What is claimed:

1. A method for authoring and accessing computer-based materials in an interconnected computer environment, said method comprising:
authoring a work on a first virtual machine of a first type executing on a first host computer;
duplicating said work from said first host computer to a second host computer; and
accessing a work on a second virtual machine of said first type executing on said second host computer.

2. The method of claim 1 wherein said first host computer is of a first host computer type and wherein said second host computer is of a second host computer type such that a work authored directly on said first host computer would not be fully compatible when accessed on said second host computer.

3. The method of claim 2 wherein said interconnected computer environment is an e-training environment.

4. The method of claim 1 wherein said first virtual machine executes on a first operating system of a first operating system type and wherein said second virtual machine executes on a second operating system of a second operating system type such that said first operating system type is not the same as said second operating system type.

5. The method of claim 4 wherein said interconnected computer environment is an e-training environment.

6. A system for authoring and accessing computer-based materials in an interconnected computer environment, said system comprising at least one subsystem for:
authoring a work on a first virtual machine of a first type executing on a first host computer;
duplicating said work from said first host computer to a second host computer; and
accessing a work on a second virtual machine of said first type executing on said second host computer.

7. The system of claim 6 further comprising at least one subsystem whereby said first host computer is of a first host computer type and whereby said second host computer is of a second host computer type such that a work authored directly on said first host computer would not be fully compatible when accessed on said second host computer.

8. The system of claim 7 further comprising at least one subsystem whereby said interconnected computer environment is an e-training environment.

9. The system of claim 6 further comprising at least one subsystem whereby said first virtual machine executes on a first operating system of a first operating system type and whereby said second virtual machine executes on a second operating system of a second operating system type such that said first operating system type is not the same as said second operating system type.

10. The system of claim 9 further comprising at least one subsystem whereby said interconnected computer environment is an e-training environment.

11. A computer-readable medium comprising computer-readable instructions for authoring and accessing computer-based materials in an interconnected computer environment, said computer-readable instructions comprising instructions for:
authoring a work on a first virtual machine of a first type executing on a first host computer;
duplicating said work from said first host computer to a second host computer; and
accessing a work on a second virtual machine of said first type executing on said second host computer.

12. The computer-readable instructions of claim 11 further comprising instructions whereby said first host computer is of a first host computer type and whereby said second host computer is of a second host computer type such that a work authored directly on said first host computer would not be fully compatible when accessed on said second host computer.

13. The computer-readable instructions of claim 12 further comprising instructions whereby said interconnected computer environment is an e-training environment.

14. The computer-readable instructions of claim 11 further comprising instructions whereby said first virtual machine executes on a first operating system of a first operating system type and whereby said second virtual machine executes on a second operating system of a second operating system type such that said first operating system type is not the same as said second operating system type.

15. The computer-readable instructions of claim 14 further comprising instructions whereby said interconnected computer environment is an e-training environment.

16. A hardware control device for authoring and accessing computer-based materials in an interconnected computer environment, said hardware control device comprising means for:
authoring a work on a first virtual machine of a first type executing on a first host computer;
duplicating said work from said first host computer to a second host computer; and
accessing a work on a second virtual machine of said first type executing on said second host computer.

17. The hardware control device of claim 16 further comprising means whereby said first host computer is of a first host computer type and whereby said second host computer is of a second host computer type such that a work authored directly on said first host computer would not be fully compatible when accessed on said second host computer.

18. The hardware control device of claim 17 further comprising means whereby said interconnected computer environment is an e-training environment.

19. The hardware control device of claim 16 further comprising means whereby said first virtual machine executes on a first operating system of a first operating system type and whereby said second virtual machine executes on a second operating system of a second operating system type such that said first operating system type is not the same as said second operating system type.

20. The hardware control device of claim 19 further comprising means whereby said interconnected computer environment is an e-training environment.
